(19) United States
(12) Patent Application Publication
(10) Pub. No.: US 2009/0305897 A1
(43) Pub. Date: Dec. 10, 2009

(54) Superconduting Composite Wire Made from Magnesium Diboride

(76) Inventors: Giovanni Grasso, Genova (IT); Andrea Malagoli, Genova (IT); Antonio Sergio Siri, Genova (IT)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/658,955

(22) PCT Filed: Jul. 30, 2004
(86) PCT No.: PCT/IT2004/000437

§ 371 Date: May 27, 2009

(51) Int. Cl. H01B 12/06

(52) U.S. Cl. 505/232; 174/125.1

(57) ABSTRACT

A superconducting composite wire with superconducting phase of magnesium diboride comprises: a core of conductive metal (1); a plurality of filaments in which each filament (3) comprises a core of magnesium diboride (5), placed around said conductive metal core (1); —an outer metallic sheath (4) for containment and mechanical reinforcement, surrounding the said plurality of filaments; and—at least one layer (2, 2a, 2b) of metal chemically compatible with magnesium diboride and capable of acting as an obstacle to the diffusion of the conductive metal of said conductive metal core (1) towards the said filaments (3), up to 980° C. where the said at least one layer is applied a) as a coating (2) of the said conductive metal core and/or b) as a coating (2a) of the said filaments (3), and/or c) as a coating (2b) of the said magnesium diboride core (5) of the said filaments (3).

The present invention relates to a superconducting composite wire or strip, comprising superconducting magnesium diboride material.

The use of superconducting materials in various industrial applications requires many precautions and protective measures. One of the most significant problems concerns the appropriate protection of a winding made with superconducting wire, in the eventuality in which the superconductivity phenomenon is interrupted for any reason, even if only momentarily.

Such an eventuality may arise, for example, if the coolant which keeps the superconducting wire constantly below its critical superconductive transition temperature is lost, even it this loss affects only a small portion of the winding. This is because superconducting materials generally have significant electrical resistance when heated to above the critical temperature: this temperature generally varies from a few Kelvin to approximately 150° K, depending on the material.

If this happens, it is essential to have an immediately available alternative electrical path, as nearly as possible parallel to the superconducting path, for the purpose of protecting the superconducting path from the passage of the electric current, which would otherwise seriously damage it.

This aim is usually achieved by connecting a closely specified portion of metallic material with low electrical resistance, such as copper, in parallel with the superconducting wire. In practice, this result can be obtained by jointly winding two wires, namely a superconducting wire and a metal wire, when the winding is formed.

However, this method can cause difficulties and complications in the winding process for any device. A greatly preferable solution is that of incorporating a low-resistance metallic material into the superconducting wire itself. However, in order to make this possible, there must be complete chemical and mechanical compatibility between the metallic material chosen as the stabilizer, the superconducting compound itself and the rest of the material making up the wire.

It is extremely difficult to find a solution to these problems in the case of superconducting wires made from magnesium diboride MgB₂. This is because magnesium diboride shows considerable chemical incompatibility with virtually all the more conductive metallic elements which might be used as stabilizers, such as copper, silver or aluminium. These elements tend to decompose the MgB₂ because of their considerable affinity for magnesium.

In order to resolve the aforementioned problems, the present invention provides a novel superconducting composite wire structure having the characteristics defined in the following claims.

According to the invention, a core of highly conductive metallic material (for example copper or silver) is incorporated in the central part of a superconducting wire comprising a plurality of magnesium diboride filaments arranged in a ring around the core.

Around the conductive core and/or around the superconducting filaments there is provided a coating which acts as a barrier to chemical diffusion, being capable of isolating chemically, but not electrically, the conductive metallic material of the core of the superconductive part.

The resulting composite is inserted into a further metallic sheath for containment and mechanical reinforcement, this sheath having the function of keeping the wire compact and providing good mechanical properties.

Thus the composite wire is internally stabilized, and can be used for producing windings and magnets without the need to wind it together with other conductive material.

Further advantages and characteristics of the invention will be made clear by the following detailed description, which refers to the attached drawings provided by way of example and without restrictive intent, in which:

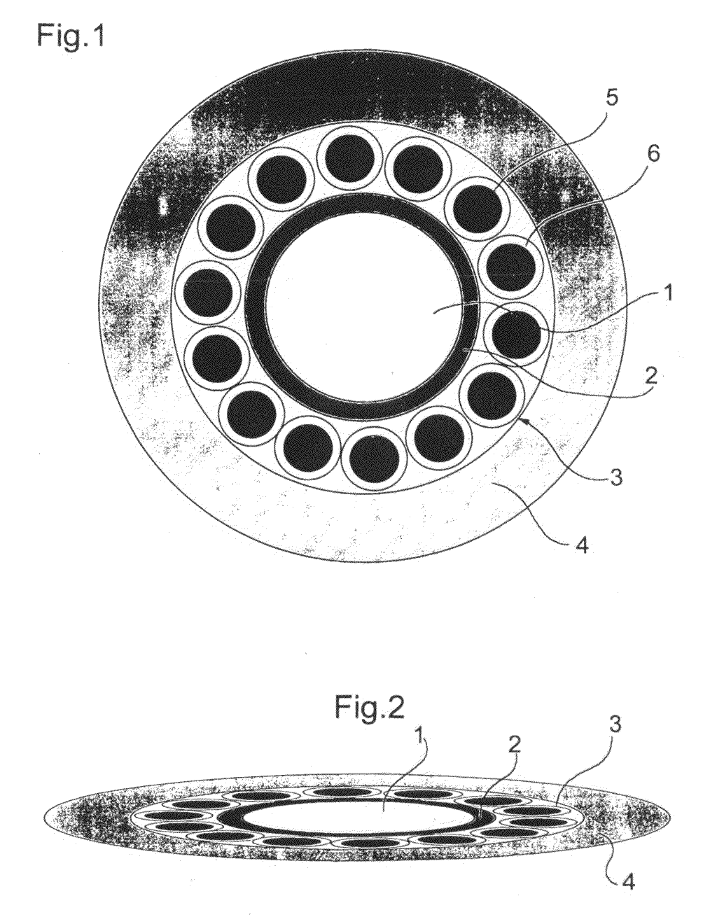

FIG. 1 is a cross-sectional view of a superconducting wire according to the invention;

FIG. 2 is a cross-sectional view of a superconducting wire having a structure similar to that of FIG. 1, made in the form of a flat wire or strip;

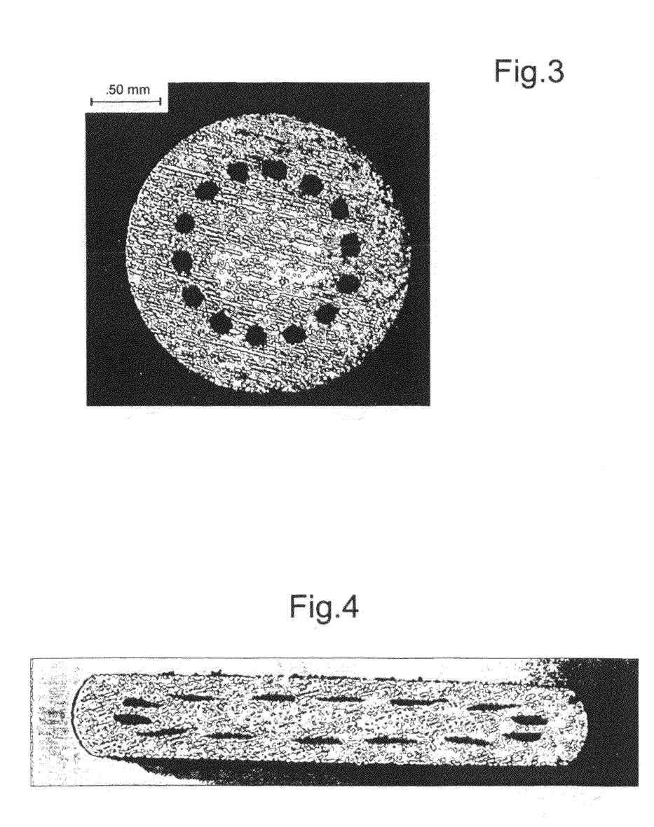

FIGS. 3 and 4 are photographs of cross sections of superconducting wires, made according to the structure of FIGS. 1 and 2; and

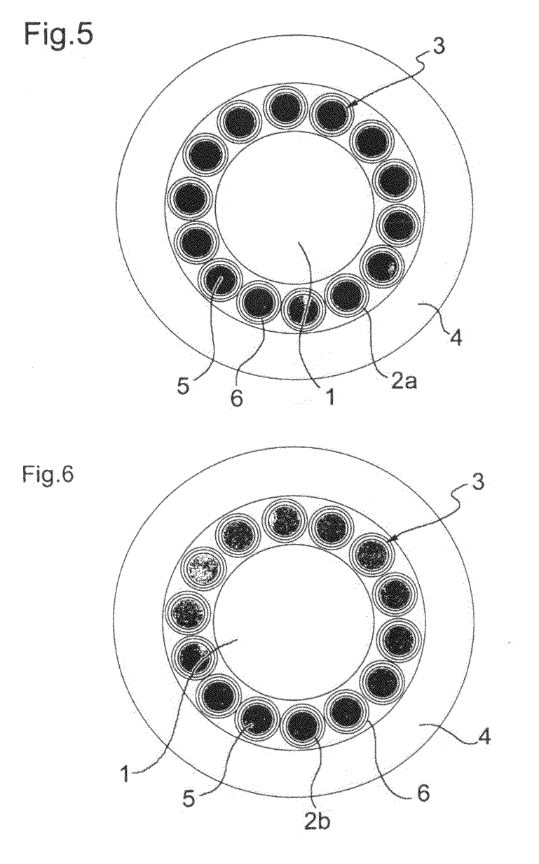

FIGS. 5 and 6 are cross-sectional views of a superconducting wire in an alternative embodiment.

In FIGS. 1 and 2, the number 1 indicates a central core of conductive metallic material. This conductive metallic material is preferably copper or silver, since these are the most conductive elements in electrical terms and can also withstand, without melting, the heat treatment to which the conductor is subjected, at temperatures ranging from 600° C. to approximately 1000° C. Preferably, copper known as OFHC (Oxygen Free High Conductivity) copper is used, since this has the highest possible electrical conductivity at low temperatures.

The central core 1 is provided with an outer coating 2 of metallic material chemically compatible with magnesium diboride, to act as a barrier or impediment to the diffusion of the conductive metal towards the said superconducting phase. This barrier can be made, for example, from niobium, tantalum, iron, nickel, tungsten, molybdenum, chromium or alloys of these, and can have a sufficient minimum thickness to impede or slow down the diffusion of the internal metallic material.

This barrier can be introduced as a thin tube or rolled sheet fitted around the high-conductivity core. Alternatively, the material forming the barrier can be deposited electrochemically or by evaporation around the high-conductivity core.

A plurality of magnesium diboride filaments 3 are positioned to surround the barrier coating 2. These filaments preferably consist of single-filament wires, each comprising a superconducting core 5 of magnesium diboride and an outer metallic sheath 6, chemically compatible with magnesium diboride.

As shown in greater detail in the examples of FIGS. 5 and 6 described below, each single-filament wire 3 can optionally comprise a barrier coating 2a or 2b outside the sheath 6, or inside the sheath 6, in other words in direct contact with the core 5.

The materials used for the sheath can be, for example, niobium, tantalum, iron, nickel, tungsten, molybdenum, chromium, or alloys of these.

The single-filament wire is preferably made by the powder-in-tube method, by the mechanical deformation of a metallic tube which has been filled with powder consisting of MgB₂ or a mixture of its constituents (essentially boron and magnesium powders).

An external sheath 4 surrounds the single-filament wires 3. The material of the external sheath can be any material having the function of containing the wire and forming the mechanical support of the wire. The materials forming the sheath can preferably be chosen from niobium, tantalum, iron, nickel, tungsten, molybdenum, chromium, or alloys of these.

The composite assembled in this way is machined by mechanical deformation in order to produce a long conductor having a circular (FIGS. 1 and 3) or flat (FIGS. 2 and 4) section. The methods used for machining the composite can include extrusion, rolling, hammering and drawing.

The quantity of wire produced will depend exclusively on the size of the initial assembly and the final size of the conductor which is to be manufactured.

Typical dimensions for a superconducting wire with internal stabilization range from diameters of 0.2 mm to 2 mm. Similarly, it is possible to produce superconducting strips having thicknesses from 0.2 mm to 2 mm and widths from 1 mm to 5 mm.

By contrast with the prior art, this type of structure of the magnesium diboride superconducting wire enables the conductor to be heat-treated at high temperatures (above 700° C.) without contamination of the superconducting phase due to the presence of the metallic element.

In a specific embodiment, shown in FIGS. 3 and 4, superconducting wires having the previously described structure were made, these wires having the cross section of either a round wire or a superconducting strip, with a central core of pure copper, a pure iron diffusion barrier, magnesium diboride superconducting filaments with pure nickel sheaths and a pure nickel outer sheath.

FIGS. 5 and 6 show alternative embodiments, which fall within the scope of the invention.

In these figures, elements corresponding to those of FIGS. 1 and 2 are indicated by the same reference numbers.

In particular, the invention allows for the possibility that the diffusion barrier 2 is not necessarily placed around the central conductive core 1, but can also—or alternatively—be placed around each filament 3, either as a coating of the containing sheath 6, or in direct contact with the superconducting core 5 of the magnesium diboride filaments.

Thus all possible combinations, in twos, of the solutions shown in FIGS. 1, 5 and 6 are allowed for, as is the use of all three solutions together.

In the example of FIG. 5, the barrier coating, indicated by 2a, coats the containing sheath 6 of each filament 3.

In the example of FIG. 6, the barrier coating, indicated by 2b, is in direct contact with the superconducting core 5 of each filament within the sheath 6.

The preceding description is applicable to the materials forming the barrier coating 2a and 2b, to the materials forming the outer metallic sheath 6 and to their application.

In the solutions of FIGS. 5 and 6, the barrier coating 2a and 2b is preferably a metal or metal alloy chosen from the previously mentioned group, but different from the material forming the sheath 6. Thus it is preferable if the barrier coating 2a, 2b is chosen from niobium, tantalum, iron and their alloys, while the material forming the sheath 6 consists of or comprises a metal chosen from niobium, tantalum, iron, nickel, tungsten, molybdenum, chromium or their alloys, this material being different from the material forming the coating 2a, 2b.

The scope of the invention also includes the case in which, in the superconducting wire, some of the filaments 3 are made in accordance with the solution of FIG. 5 and other filaments are made in accordance with the solution of FIG. 6, optionally with the presence of a coating layer 2 on the conductive core 1.

In all cases, the composite materials thus produced have undergone heat treatments at up to 980° C. without decomposition of the magnesium diboride due to the presence of copper.

1. A superconducting composite wire with a superconductive phase of magnesium diboride, comprising:
a core of conductive metal;
a plurality of filaments, wherein each of the plurality of filaments has a core of magnesium diboride, the plurality of filaments placed around the core of conductive metal;
an outer metallic sheath surrounding the plurality of filaments, the outer metallic sheath providing containment and mechanical reinforcement; and
at least one layer of metal applied as a coating to the core of conductive metal and/or applied as a coating to each of the plurality of filaments, the at least one layer of metal is chemically compatible with magnesium diboride, the at least one layer of metal is capable of acting as an obstacle to the diffusion of the core of conductive metal towards the plurality of filaments.

2. (canceled)

3. The superconducting composite wire according to claim 1, wherein the at least one layer of metal applied as a coating to each of the plurality of filaments is in direct contact with the core of magnesium diboride.

4. The superconducting composite wire according to claim 1, wherein the core of magnesium diboride of each of the plurality of filaments is surrounded by a metallic sheath, and wherein the at least one layer of metal is applied as an outer coating of the metallic sheath.

5. The superconducting composite wire according to claim 4, wherein the at least one layer of metal is applied as a coating of the core of magnesium diboride inside the metallic sheath.

6. A superconducting composite wire, comprising: a core of conductive metal; a coating layer of metal surrounding the core of conductive metal, the coating layer of metal chemically compatible with magnesium diboride, and the coating layer of metal capable of acting as an obstacle to the diffusion of the core of conductive metal; a plurality of magnesium diboride filaments placed around the coating layer of metal surrounding the core of conductive metal, each filament having a coating or sheath of metal that is chemically compatible with magnesium diboride; and an outer metallic sheath surrounding the plurality of magnesium diboride filaments for containment and mechanical reinforcement.

7. The superconducting composite wire according to claim 1, wherein the at least one layer of metal is selected from the group consisting of niobium, tantalum, iron, nickel, tungsten, molybdenum, chromium and their alloys.

8. The superconducting composite wire according to claim 7, wherein the at least one layer of metal is a tube or a rolled sheet, or the at least one layer of metal is produced by electrochemical deposition or by evaporation.

9. The superconducting composite wire according to claim 1, wherein the plurality of filaments have single-filament wires, the single-filament wires further comprising a superconducting magnesium diboride core and an outer sheath of metal chemically compatible with magnesium diboride.

10. The superconducting composite wire according to claim 9, wherein the outer sheath of metal is selected from the group consisting of niobium, tantalum, iron, nickel, tungsten, molybdenum, chromium and their alloys.

11. The superconducting composite wire according to claim 1, wherein the outer metallic sheath is selected from the group consisting of niobium, tantalum, iron, nickel, tungsten, molybdenum, chromium and their alloys.

12. The superconducting composite wire according to claim 4, wherein the at least one layer of metal is selected from the group consisting of niobium, tantalum, iron and their alloys, and the metallic sheath surrounding the magnesium diboride core is selected from the group consisting of nickel, tungsten, molybdenum, chromium and their alloys.

13. The superconducting composite wire according to claim 1, wherein the core of conductive metal comprises copper or silver.

14. The superconducting composite according to claim 1, further comprising a circular or flat cross section.

15. The superconducting composite wire according to claim 3, wherein the at least one layer of metal is selected from the group consisting of niobium, tantalum, iron, nickel, tungsten, molybdenum, chromium and their alloys.

16. The superconducting composite wire according to claim 6, wherein the coating layer of metal surrounding the core of conductive metal is selected from the group consisting of niobium, tantalum, iron, nickel, tungsten, molybdenum, chromium and their alloys.

17. The superconducting composite wire according to claim 3, wherein the plurality of filaments have single-filament wires, the single-filament wires further comprising a superconducting magnesium diboride core and an outer sheath of metal that is chemically compatible with magnesium diboride.

18. The superconducting composite wire according to claim 4, wherein the plurality of filaments have single-filament wires, the single-filament wires further comprising a superconducting magnesium diboride core and an outer sheath of metal that is chemically compatible with magnesium diboride.

19. The superconducting composite wire according to claim 6, wherein the plurality of magnesium diboride filaments have single-filament wires, the single-filament wires further comprising a superconducting magnesium diboride core and an outer sheath of metal that is chemically compatible with magnesium diboride.

20. The superconducting composite wire according to claim 6, wherein the outer metallic sheath is selected from the group consisting of niobium, tantalum, iron, nickel, tungsten, molybdenum, chromium and their alloys.

21. The superconducting composite wire according to claim 5, wherein the at least one layer of metal is selected from the group consisting of niobium, tantalum, iron and their alloys, and the metallic sheath surrounding the magnesium diboride core is selected from the group consisting of nickel, tungsten, molybdenum, chromium and their alloys.
